(19) United States
(12) Patent Application Publication
(10) Pub. No.: US 2020/0364555 A1
(43) Pub. Date: Nov. 19, 2020

(54) MACHINE LEARNING SYSTEM

(71) Applicant: Prowler.io Limited, Cambridge (GB)

(72) Inventors: Jordi GRAU-MOYA, Cambridge (GB); Felix LEIBFRIED, Cambridge (GB); Haitham BOU AMMAR, Cambridge (GB)

(73) Assignee: Prowler.io Limited, Cambridge (GB)

(21) Appl. No.: 16/759,241

(22) PCT Filed: Oct. 26, 2018
(86) PCT No.: PCT/EP2018/079489

§ 371 Date: Apr. 24, 2020

(30) Foreign Application Priority Data
Oct. 27, 2017 (EP) 17275175.2

(51) Int. Cl. G06N 3/08; G06N 3/04

(52) U.S. Cl. CPC G06N 3/08; G06N 3/0472; G06N 3/0454

(57) ABSTRACT

There is disclosed a machine learning technique of determining a policy for an agent controlling an entity in a two-entity system. The method comprises assigning a prior policy and a respective rationality to each entity of the two-entity system, each assigned rationality being associated with a permitted divergence of a policy associated with the associated entity from the prior policy p assigned to that entity, and determining the policy to be followed by an agent corresponding to one entity by optimising an objective function F*(s), wherein the objective function F*(s) includes factors dependent on the respective rationalities and prior policies assigned to the two entities. In this way, the policy followed by an agent controlling an entity in a system can be determined taking into account the rationality of another entity within the system.

### TECHNICAL FIELD

This invention is in the field of machine learning systems, and has particular applicability to a two-entity reinforcement learning system.

### BACKGROUND

Machine learning involves a computer system learning what to do by analysing data, rather than being explicitly programmed what to do. While machine learning has been investigated for over fifty years, in recent years research into machine learning has intensified. Much of this research has concentrated on what are essentially pattern recognition systems.

In addition to pattern recognition, machine learning can be utilised for decision making. Many uses of such decision making have been put forward, from managing a fleet of taxis to controlling non-playable characters in a computer game. The practical implementation of such decision making presents many technical challenges.

### SUMMARY

According to a first aspect of the present invention, there is provided a machine learning method of determining a policy for an agent controlling an entity in a two-entity system. The method comprises assigning a prior policy and a respective rationality to each entity of the two-entity system, each assigned rationality being associated with a permitted divergence of a policy associated with the associated entity from the prior policy p assigned to that entity, and determining the policy to be followed by an agent corresponding to one entity by optimising an objective function F*(s). By including in the objective function F*(s) factors dependent on the respective rationalities and prior policies assigned to the two entities, the performance of the agent can be varied away from optimal performance in accordance with the corresponding assigned rationality.

In an example, the other of the two entities acts in accordance with control signals derived from human inputs. Such an arrangement may be employed, for example, in a computer game where the machine-controlled entity is a non-playable participant within the game. For a two-entity system involving a human-controlled entity, a respective rationality can be assigned to each agent by recording a data set comprising a plurality of tuples, each tuple comprising data indicating a state at a corresponding time and respective actions performed by the two entities in that state, and processing the data set to estimate a rationality for the human-controlled entities. The rationality for the human-controlled entity is then assigned in dependence on the estimated rationality. As rationality is linked to divergence from the optimal policy, the rationality can be viewed as a skill level for a player. In this way, for example, in a game the skill level of an autonomous agent can be set the same as, slightly worse than or slightly better than a human player based on the estimated rationality of the human-controlled entity.

According to another aspect of the invention, there is provided a machine learning method of determining a skill level for a player, the method comprising recording a data set comprising a plurality of tuples, each tuple comprising data indicating a state at a corresponding time and respective actions performed by a human-controlled entity in that state, and processing the data set to estimate a rationality for the human-controlled entities in accordance with a policy. As rationality is linked to divergence from the policy, the rationality can be viewed as a skill level for a player.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic diagram showing the main components of a data processing system used to implement methods according to a first embodiment of the invention;

FIG. 2 is a schematic diagram showing the main components of a data processing system used to implement methods according to a second embodiment of the invention;

FIG. 3 is a flow diagram representing a data processing routine implemented by the data processing system of FIG. 1.

FIG. 4 is a flow diagram representing a routine for updating an objective function estimate.

FIG. 5 is a flow diagram representing a routine for updating an estimated objective function estimate and a rationality estimate.

FIG. 6 is a flow diagram representing a routine for determining a policy of an agent.

FIG. 7 is a flow diagram representing a routine for estimating the rationality of an entity.

FIG. 8 is a schematic diagram of a first deep neural network (DNN) configured for use in an embodiment of the present invention.

FIG. 9 is a schematic diagram of a second deep neural network (DNN) configured for use in an embodiment of the present invention.

FIG. 10 is a schematic diagram of a server used to implement a learning subsystem in accordance with the present invention.

FIG. 11 is a schematic diagram of a user device used to implement an interaction subsystem in accordance with the present invention.

### DETAILED DESCRIPTION

### Reinforcement Learning: Overview

For the purposes of the following description and accompanying drawings, a reinforcement learning problem is definable by specifying the characteristics of one or more agents and an environment. The methods and systems described herein are applicable to a wide range of reinforcement learning problems, including both continuous and discrete high-dimensional state and action spaces

A software agent, referred to hereafter as an agent, is a computer program component that makes decisions based on a set of input signals and performs actions based on these decisions. In some applications of reinforcement learning, each agent is associated with a real-world entity (for example a taxi in a fleet of taxis). In other applications of reinforcement learning, an agent is associated with a virtual entity (for example, a non-playable character (NPC) in a video game). In some examples, an agent is implemented in software or hardware that is part of a real world entity (for example, within an autonomous robot). In other examples, an agent is implemented by a computer system that is remote from the real world entity.

An environment is a virtual system with which agents interact, and a complete specification of an environment is referred to as a task. In many practical examples of reinforcement learning, the environment simulates a real-world system, defined in terms of information deemed relevant to the specific problem being posed.

It is assumed that interactions between an agent and an environment occur at discrete time steps t=0, 1, 2, 3, . . . . The discrete time steps do not necessarily correspond to times separated by fixed intervals. At each time step, the agent receives data corresponding to an observation of the environment and data corresponding to a reward. The data corresponding to an observation of the environment is referred to as a state signal and the observation of the environment is referred to as a state. The state perceived by the agent at time t is labelled sₜ. The state observed by the agent may depend on variables associated with the agent itself. In response to receiving a state signal indicating a state sₜ at a time t, an agent is able to select and perform an action aₜ from a set of available actions in accordance with a Markov Decision Process (MDP). In some examples, the state signal does not convey sufficient information to ascertain the true state of the environment, in which case the agent selects and performs the action aₜ in accordance with a Partially-Observable Markov Decision Process (PO-MDP). Performing a selected action generally has an effect on the environment. Data sent from an agent to the environment as an agent performs an action is referred to as an action signal. At a later time +1, the agent receives a new state signal from the environment indicating a new state sₜ₊₁. The new state signal may either be initiated by the agent completing the action aₜ, or in response to a change in the environment.

Depending on the configuration of the agents and the environment, the set of states, as well as the set of actions available in each state, may be finite or infinite. The methods and systems described herein are applicable in any of these cases.

Having performed an action aₜ, an agent receives a reward signal corresponding to a numerical reward Rₜ₊₁, where the reward Rₜ₊₁ depends on the state sₜ, the action aₜ and the state sₜ₊₁. The agent is thereby associated with a sequence of states, actions and rewards (sₜ, aₜ, Rₜ₊₁, sₜ₊₁, . . . ) referred to as a trajectory T. The reward is a real number that may be positive, negative, or zero.

In response to an agent receiving a state signal, the agent selects an action to perform based on a policy. A policy is a stochastic mapping from states to actions. If an agent follows a policy π, and receives a state signal at time t indicating a specific state sₜ=s, the probability of the agent selecting a specific action aₜ=a is denoted by π(a|s). A policy for which π(a|s) takes values of either 0 or 1 for all possible combinations of a and s is a deterministic policy. Reinforcement learning algorithms specify how the policy of an agent is altered in response to sequences of states, actions, and rewards that the agent experiences.

Generally, the objective of a reinforcement learning algorithm is to find a policy that maximises the expectation value of a return, where the value of a return Gₙ at any time depends on the rewards received by the agent at future times. For some reinforcement learning problems, the trajectory T is finite, indicating a finite sequence of time steps, and the agent eventually encounters a terminal state S_{T} from which no further actions are available. In a problem for which T is finite, the finite sequence of time steps refers to an episode and the associated task is referred to as an episodic task. For other reinforcement learning problems, the trajectory T is infinite, and there are no terminal states. A problem for which T is infinite is referred to as an infinite horizon task. As an example, a possible definition of the return is given by Equation (1) below:

$${G}_{t} = {\sum }_{j = 0}^{T - t - 1} {γ}^{j} {R}_{t + j + 1} , \qquad ( 1 )$$

in which γ is a parameter called the discount factor, which satisfies 0≤γ≤1, with γ=1 only being permitted if T is finite. Equation (1) states that the return assigned to an agent at time step n is the sum of a series of future rewards received by the agent, where terms in the series are multiplied by increasing powers of the discount factor. Choosing a value for the discount factor affects how much an agent takes into account likely future states when making decisions, relative to the state perceived at the time that the decision is made. Assuming the sequence of rewards {Rⱼ} is bounded, the series in Equation (1) is guaranteed to converge. A skilled person will appreciate that this is not the only possible definition of a return. For example, in R-learning algorithms, the return given by Equation (1) is replaced with an infinite sum over undiscounted rewards minus an average expected reward. The applicability of the methods and systems described herein is not limited to the definition of return given by Equation (1).

Two different expectation values are often referred to: the state value and the action value respectively. For a given policy π, the state value function V(s) is defined for each state s by the equation V(s)= [symbol] _{π}(Gₜ|sₜ=s), which states that the state value of state s given policy π is the expectation value of the return at time t, given that at time t the agent receives a state signal indicating a state sₜ=s. Similarly, for a given policy π, the action value function Q(s, a) is defined for each possible state-action pair (s, a) by the equation Q (s, a)= [symbol] _{π}(Gₜ|sₜ=s, aₜ=a), which states that the action value of a state-action pair (s, a) given policy π is the expectation value of the return at time step t, given that at time t the agent receives a state signal indicating a state sₜ=s, and selects an action aₜ=a. A computation that results in a calculation or approximation of a state value or an action value for a given state or state-action pair is referred to as a backup.

In many practical applications of reinforcement learning, the number of possible states or state-action pairs is very large or infinite, in which case it is necessary to approximate the state value function or the action value function based on sequences of states, actions, and rewards experienced by the agent. For such cases, approximate value functions \hat{ν}(s, w) and \hat{q}(s, a, w) are introduced to approximate the value functions V(s) and Q(s, a) respectively, in which w is a vector of parameters defining the approximate functions. Reinforcement learning algorithms then adjust the parameter vector w in order to minimise an error (for example a root-mean-square error) between the approximate value functions \hat{ν}(s, w) or \hat{q}(s, a, w) and the value functions V(s) or Q(s, a).

### Example System Architecture

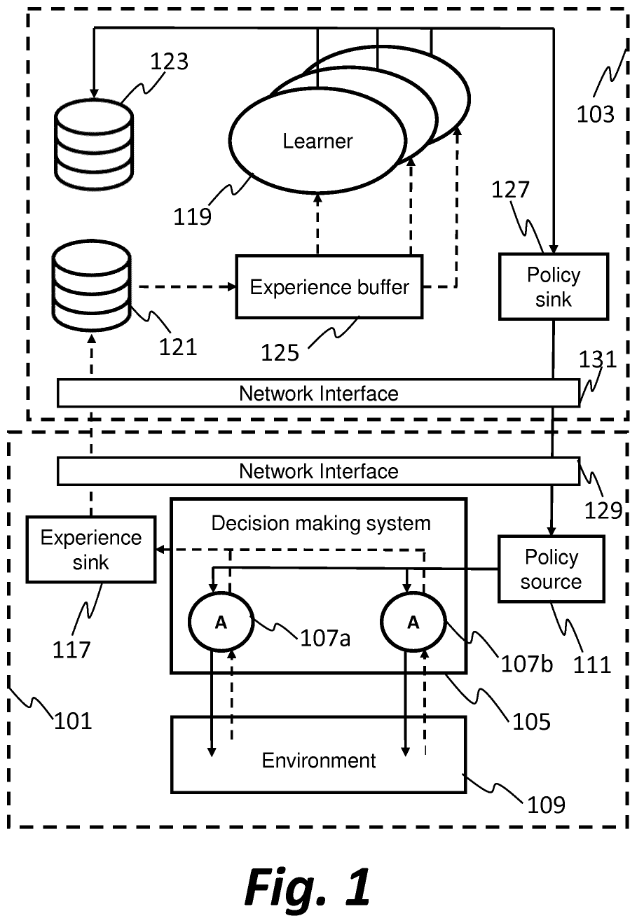

The data processing system of FIG. 1 is an example of a system capable of implementing a reinforcement learning routine in accordance with embodiments of the present invention. The system includes interaction subsystem 101 and learning subsystem 103.

Interaction subsystem 101 includes decision making system 105, which comprises agents 107a and 107b. Agent 107a is referred to as the player, and agent 107b is referred to as the opponent. Agents 107a and 107b perform actions on environment 109 depending on state signals received from environment 109, with the performed actions selected in accordance with policies received from policy source 111. Interaction system also includes experience sink 117, which sends experience data to learning subsystem 103.

Learning subsystem 103 includes learner 119, which is a computer program that implements a learning algorithm. In a specific example, learner 119 includes several deep neural networks (DNNs), as will be described herein. However, the learner may also implement learning algorithms which do not involve DNNs. Learning subsystem 119 also includes two databases: experience database 121 and skill database 123. Experience database 121 stores experience data generated by interaction system 101, referred to as an experience record. Skill database 123 stores policy data generated by learner 119. Learning subsystem also includes experience buffer 125, which processes experience data in preparation for being sent to learner 119, and policy sink 127, which sends policy data generated by learner 119 to interaction subsystem 101.

Data is sent between interaction subsystem 101 and learning subsystem 103 via communication module 129 and communication module 131. Communication module 129 and communication module 131 are interconnected by a communications network (not shown). More specifically, in this example the network is the Internet, learning subsystem 103 includes several remote servers hosted on the Internet, and interaction subsystem 101 includes a local server. Learning subsystem 103 and interaction subsystem 101 interact via an application programming interface (API).

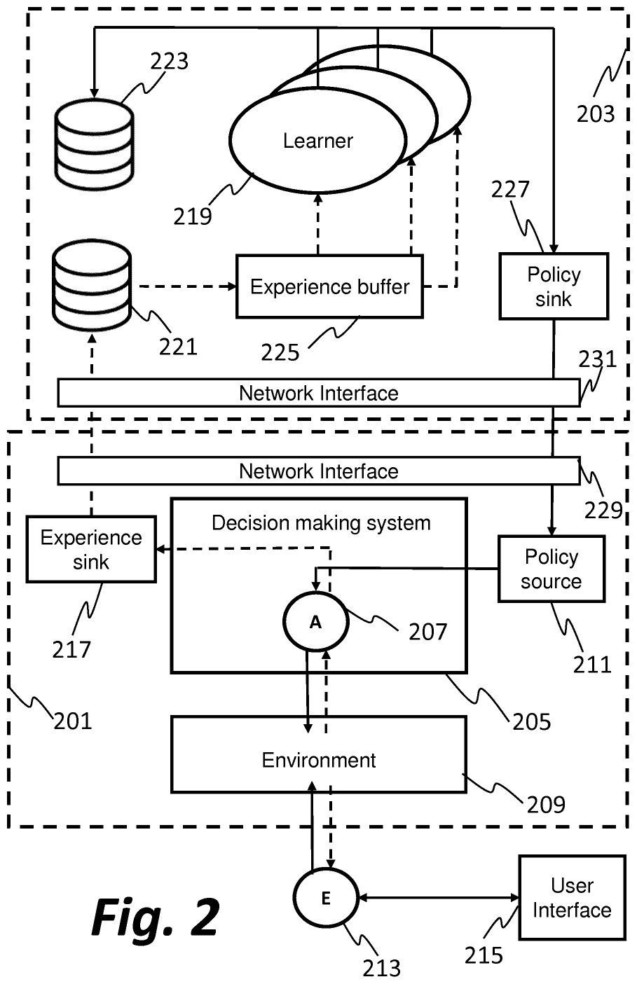

FIG. 2 illustrates a similar data processing system to that of FIG. 1. However, decision making system 205 comprises only one agent, agent 207, which is referred to as the player. In addition to agent 207, opponent entity 213 interacts with environment 209. In this example, opponent entity 213 is a human-controlled entity capable of performing actions on environment 209. A user interacts with opponent entity 213 via user interface 215.

### Example Data Processing Routine

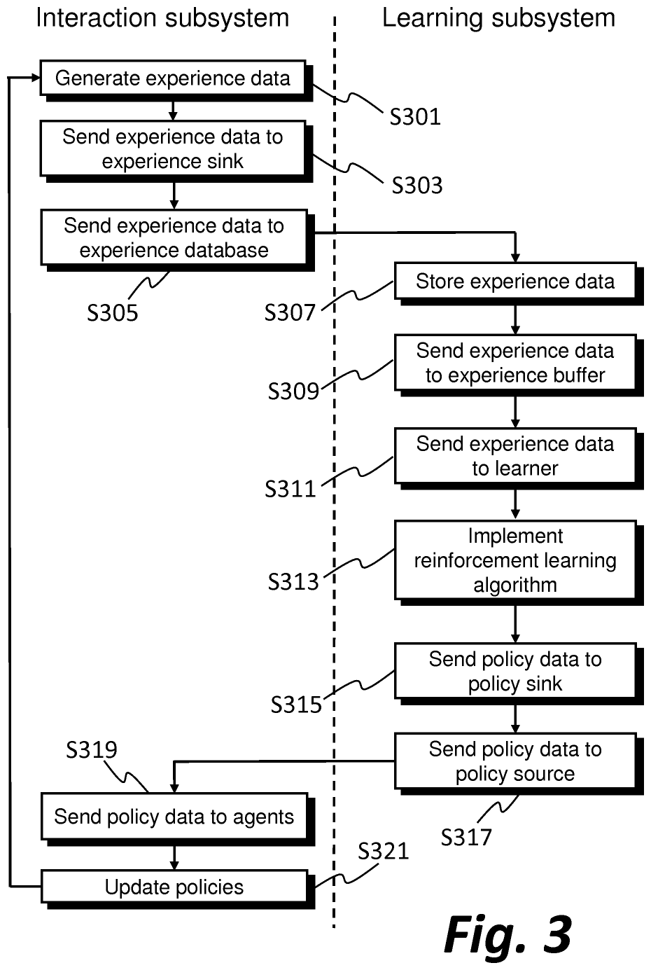

FIG. 3 illustrates how the system of FIG. 1 implements a data processing operation in accordance with the present invention. The interaction subsystem generates, at S301, experience data corresponding to an associated trajectory consisting of successive triplets of state-action pairs and rewards. The experience data comprises a sequence of tuples (sₜ, aₜ^{(pl)}, aₜ^{(opp)}, s′ₜ) for t=1, 2, . . . , in which sₜ is an observation of the environment at time step t, aₜ^{(pl)} and aₜ^{(opp)} are actions performed by the player (agent 107a) and the opponent (agent 107b) respectively, and s′ₜ is an observation of the environment immediately after the player and opponent have performed the actions aₜ^{(pl)} and aₜ^{(opp)}. Decision making system 105 sends, at S303, experience data corresponding to sequentially generated tuples to experience sink 117. Experience sink 117 transmits, at S305, the experience data to experience database 121 via a communications network. Experience database 121 stores, at S307, the experience data received from experience sink 117.

Experience database 121 sends, at S309, the experience data to experience buffer 125, which arranges the experience data into an appropriate data stream for processing by learner 119. Experience buffer 121 sends, at S311, the experience data to learner 119.

Learner 119 receives experience data from experience buffer 125 and implements, at S313, a reinforcement learning algorithm in accordance with the present invention in order to generate policy data for agents 107a and 107b. In some examples, learner 119 comprises one or more Deep Neural Networks (DNNs), as will be described with reference to specific learning routines.

Learner 119 sends, at S315, policy data to policy sink 127. Policy sink 127 sends, at S317, the policy data to policy source 111 via the network. Policy source 111 then sends, at S319, the policy data to agents 107a and 107b, causing the policies of agents 107a and 107b to be updated at S321. At certain times (for example, when a policy is measured to satisfy a given performance metric), learner 119 also sends policy data to skill database 123. Skill database 123 stores a skill library including data relating to policies learned during the operation of the data processing system, which can later be provided to agents and/or learners in order to negate the need to relearn the same policies from scratch.

### Bounded Rationality

An optimal policy π* in normal reinforcement learning is one that maximises an objective V(s) (the state value function). An optimal state value function V*(s) for an infinite horizon task is given by:

$${V}^{*} ( s ) = {max}_{π} 𝔼 [ {\sum }_{t = 0}^{∞} {γ}^{t} R ( {s}_{t} , {a}_{t} ) ] . \qquad ( 2 )$$

An entity that follows an optimal rational policy π* can be stated to be perfectly rational. By introducing into the reinforcement learning algorithm a constraint restricting divergence from a prior policy ρ, the entities no longer act in a perfectly rational manner. In this case, the objective of the reinforcement learning algorithm is to identify a policy that maximises an objective function V(s) that is subject to the constraint that the Kullback-Leibler (KL) divergence between the policy π and a predefined prior policy ρ is less than a positive constant C:

$${\sum }_{t = 0}^{∞} {γ}^{t} KL ( π ( {a}_{t} \vert {s}_{t} ) \vert \vert ρ ( {a}_{t} \vert {s}_{t} ) ) \leq C . \qquad ( 3 )$$

The smaller the value of C, the stricter the constraint and therefore the more similar the determined policy π will be to the prior policy ρ and the less similar the determined policy π will be to the optional rational policy π*.

The bounded rationality case can be reformulated as an unconstrained maximisation problem using a Lagrange multiplier β, leading to an objective that is solved by an objective function satisfying:

$${F}^{*} ( s ) = {max}_{π} 𝔼 [ {\sum }_{t = 0}^{∞} {γ}^{t} ( R ( {s}_{t} , {a}_{t} ) - \frac{1}{β} log \frac{π ( {a}_{t} \vert {s}_{t} )}{ρ ( {a}_{t} \vert {s}_{t} )} ) ] . \qquad ( 4 )$$

Increasing the Lagrange multiplier β has an effect equivalent to increasing C in Equation (3). Note that as β→∞ the determined policy π converges to the optimal rational policy π* and F*_{β→∞}(s)=V*(s), whereas as β→0 the determined policy π converges on the prior policy ρ and F*_{β→0}(s)=V^{ρ}(s).

The subtracted term in equation (4) bounds the rationality of the corresponding entity, because it makes the agent make decisions more according to the prior policy (which might not be fully rational), and less according to the optimal rational policy π*.

### Two-Entity Bounded Rationality

For a two-entity system, i.e. a system involving exactly two entities, each entity can follow its own policy, and chooses actions accordingly. Each entity may have a corresponding agent. For example, in the context of a computer game involving a machine-controlled player and a machine-controlled opponent, one agent may be associated with the player while the other agent may be associated with the opponent. The agent for the player will select an action aₜ^{(pl)} in accordance with policy πₚₗ and the agent for the opponent will select an action aₜ^{(op)} in accordance with policy πₒₚ such that:

aₜ^{(pl)}˜πₚₗ(aₜ^{(pl)}|sₜ), (5)

aₜ^{(opp)}˜πₒₚₚ(aₜ^{(opp)}|sₜ) (6)

In effect, these equations say: given a state sₜ, the action of the player/opponent is chosen according to a probability distribution over possible actions available to the player/opponent in that state, the probability distribution being specified by the policy of the player/opponent.

Given a pair of actions aₜ^{(pl)}, aₜ^{(opp)} being performed at time t, the state of the environment transitions according to a probability distribution specified by a joint transition model:

sₜ₊₁˜T(sₜ₊₁|sₜ, aₜ^{(pl)},aₜ^{(opp)}) (7)

Although this transition could be deterministic, in which case a given pair of actions aₜ^{(pl)}, aₜ^{(opp)} being performed in a state sₜ will always lead to the same successor state sₜ₊₁, more generally this is not the case, in which case Equation (7) is stochastic.

The agents receive a joint reward R(sₜ, aₜ^{(pl)}, aₜ^{(opp)}). For collaborative settings, both entities seek positive rewards. For adversarial settings, the player seeks positive rewards and the opponent seeks negative rewards (or vice-versa).

Assuming that the rationality of the player/opponent is represented by a Lagrange multiplier, an objective of the reinforcement learning can be represented as optimising a function of the form:

$${F}^{*} ( s ) = {max}_{{π}_{pl}} {ext}_{{π}_{opp}} 𝔼 [ {\sum }_{t = 0}^{∞} {γ}^{t} ( R ( {s}_{t} , {a}_{t}^{( p l )} , {a}_{t}^{( opp )} ) - \frac{1}{{β}_{pl}} log \frac{{π}_{pl} ( {a}_{t}^{( pl )} \vert {s}_{t} )}{{ρ}_{pl} ( {a}_{t}^{( pl )} \vert {s}_{t} )} - \frac{1}{{β}_{opp}} log \frac{{π}_{opp} ( {a}_{t}^{( opp )} \vert {s}_{t} )}{{ρ}_{opp} ( {a}_{t}^{( opp )} \vert {s}_{t} )} ) ] . \qquad ( 8 )$$

For collaborative settings in which the player and the opponent collaborate to maximise the return, βₒₚₚ>0 and ext=max. For adversarial settings, where the player aims to maximise the return and the opponent aims to minimise the return, βₒₚₚ<0 and ext=min.

Equation (8) refers to a separate predefined prior policy ρ for the player and for the opponent. The subtracted terms bound the rationality of the two respective entities. The aim is to solve the problem posed by Equation (8) for the two unknown policies πₚₗ and πₒₚₚ. To do so, an optimal joint action function F*(s, a^{(pl)}, a^{(opp)}) is introduced via Equation (9):

$${F}^{*} ( s , {a}^{( pl )} , {a}^{( opp )} ) = R ( s , {a}^{( pl )} , {a}^{( opp )} ) + γ {\sum }_{{s}^{′}} T ( {s}^{′} \vert s , {a}^{( pl )} , {a}^{( opp )} ) {F}^{*} ( {s}^{′} ) . \qquad ( 9 )$$

Given F*(s, a^{(pl)}, a^{(opp)}), the corresponding optimal function F*(s) is computed using Equations (10) and (11):

$$\begin{matrix}{F}^{*} ( s , {a}^{( pl )} ) = \frac{1}{{β}_{opp}} log {\sum }_{{a}^{( opp )}} {ρ}_{opp} ( {a}^{( opp )} \vert s ) exp ( {β}_{opp} {F}^{*} ( s , {a}^{( pl )} , {a}^{( opp )} ) ) , & ( 10 ) \\ {F}^{*} ( s ) = \frac{1}{{β}_{pl}} log {\sum }_{{a}^{( pl )}} {ρ}_{pl} ( {a}^{( pl )} \vert s ) exp ( {β}_{pl} {F}^{*} ( s , {a}^{( pl )} ) ) . & ( 11 )\end{matrix}$$

Equations (9) to (11) form a set of simultaneous equations to be solved for F*(s, a^{(pl)}, a^{(opp)}). In an example, the solution proceeds using a Q-learning-type learning algorithm to incrementally update an estimate F(s, a^{(pl)}, a^{(opp)}) until it converges to a satisfactory estimate of the optimal function F*(s, a^{(pl)}, a^{(opp)}) that solves Equations (9) to (11). As Q-learning is an off-policy method, during learning the player and opponent can follow any policy (for example, uniformly random exploration) and the estimate F(s, a^{(pl)}, a^{(opp)}) will still converge to the function F*(s, a^{(pl)}, a^{(opp)}) provided that there is sufficient exploration of the state space.

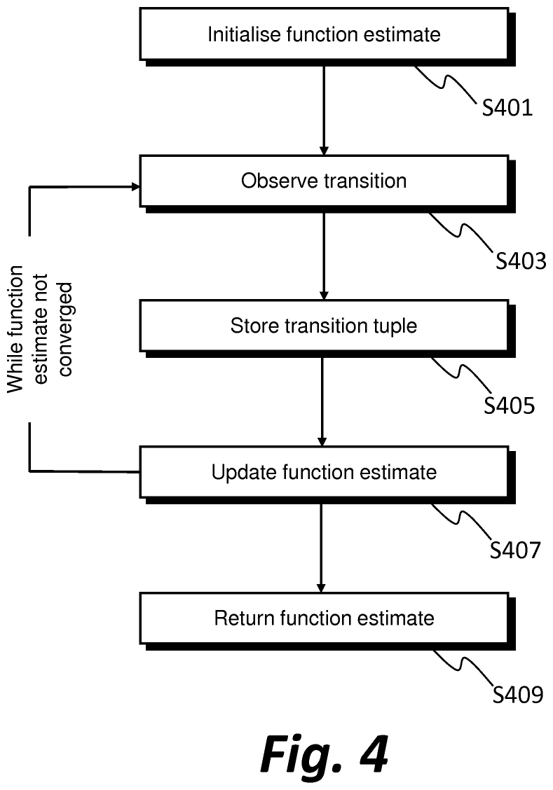

FIG. 4 represents an example of routine that is implemented by a learner to determine an estimate F(s, a^{(pl)}, a^{(opp)}) of the function F*(s, a^{(pl)}, a^{(opp)}) that solves Equations (9) to (11). The learner implements a Q-learning-type algorithm, in which the estimate F(s, a^{(pl)}, a^{(opp)}) is updated incrementally whilst a series of transitions in a two-entity system is observed. The learner starts by initialising, at S401, a function estimate F(s, a^{(pl)}, a^{(opp)}) to zero for all possible states and available actions for the player and the opponent. The player and opponent select actions according to respective policies as shown by Equations (5) and (6). The learner observes, at S403, an action of each of the two entities, along with the corresponding transition from a state sₜ to successor state s′ₜ. The learner stores, at S405, a tuple of the form (sₜ, aₜ^{(pl)}, aₜ^{(opp)}, s′ₜ) associated with the transition.

The learner updates, at S407, the function estimate F(s, a^{(pl)}, a^{(opp)}). In this example, in order to update the function estimate F(s, a^{(pl)}, a^{(opp)}), the learner first substitutes the present estimate of F(s, a^{(pl)}, a^{(opp)}) into Equation (10) to calculate an estimate F(sₜ, aₜ^{(pl)}) of F*(sₜ, aₜ^{(pl)}), then substitutes the calculated estimate F(sₜ, aₜ^{(pl)}) into Equation (11) to calculates an estimate F(s′ₜ) of F*(s′ₜ). The learner then uses the estimate F(s′ₜ) to update the estimate F(sₜ, aₜ^{(pl)}, aₜ^{(opp)}), as shown by Equation (12):

F(sₜ, aₜ^{(pl)},aₜ^{(opp)})←F(sₜ,aₜ^{(pl)},aₜ^{(opp)})+a(Rₜ+γF(s′ₜ)−F(sₜ,aₜ^{(pl)},aₜ^{(opp)})). (12)

The learner continues to update function estimates as transitions are observed until the function estimate F(s, a^{(pl)}, a^{(opp)}) has converged sufficiently according to predetermined convergence criteria. The learner returns, at S609, the converged function estimate F(s, a^{(pl)}, a^{(opp)}), which is an approximation of the optimal function F*(s, a^{(pl)}, a^{(opp)}).

Once a satisfactory estimate of F*(s, a^{(pl)}, a^{(opp)}) has been obtained, for example using the routine of FIG. 4, policies that optimise the objective of Equation (8) are given by Equations (13) and (14):

$$\begin{matrix}{π}_{pl}^{*} ( {a}^{( pl )} \vert s ) = \frac{1}{{Z}_{pl} ( s )} {ρ}_{pl} ( {a}^{( pl )} \vert s ) \times exp ( \frac{{β}_{pl}}{{β}_{opp}} {\sum }_{{a}^{( opp )}} {ρ}_{opp} ( {a}^{( opp )} \vert s ) exp ( {β}_{opp} {F}^{*} ( s , {a}^{( pl )} , {a}^{( opp )} ) ) ) , & ( 13 ) \\ {π}_{opp}^{*} ( {a}^{( opp )} \vert s ) = \frac{1}{{Z}_{opp} ( s )} {ρ}_{opp} ( {a}^{( opp )} \vert s ) \times exp ( \frac{{β}_{opp}}{{β}_{pl}} {\sum }_{{a}^{( pl )}} {ρ}_{pl} ( {a}^{( pl )} \vert s ) exp ( {β}_{pl} {F}^{*} ( s , {a}^{( pl )} , {a}^{( opp )} ) ) ) , & ( 14 )\end{matrix}$$

in which the normalising terms Zₚₗ(s) and Zₒₚₚ(s) are given by:

$$\begin{matrix}{Z}_{pl} ( s ) = {\sum }_{{a}^{( pl )}} {ρ}_{pl} ( {a}^{( pl )} \vert s ) \times exp ( \frac{{β}_{pl}}{{β}_{opp}} {\sum }_{{a}^{( opp )}} {ρ}_{opp} ( {a}^{( opp )} \vert s ) exp ( {β}_{opp} {F}^{*} ( s , {a}^{( pl )} , {a}^{( opp )} ) ) ) , \\ and & ( 15 ) \\ {Z}_{opp} ( s ) = {\sum }_{{a}^{( opp )}} {ρ}_{opp} ( {a}^{( opp )} \vert s ) \times exp ( \frac{{β}_{opp}}{{β}_{pl}} {\sum }_{{a}^{( pl )}} {ρ}_{pl} ( {a}^{( pl )} \vert s ) exp ( {β}_{pl} {F}^{*} ( s , {a}^{( pl )} , {a}^{( opp )} ) ) ) . & ( 16 )\end{matrix}$$

### Estimating the Opponent's Rationality

When both entities are machine-controlled, as in the system of FIG. 1, the rationality of both the player and the opponent can be set and parameterised by the Lagrange multipliers βₚₗ and βₒₚₚ respectively. In that case, the objective is to find policies for both the player and the opponent according to the predetermined degrees of rationality.

If, however, rationality of the player entity is known but the rationality of the opponent entity is unknown, then it is necessary to estimate the Lagrange multiplier βₒₚₚ corresponding to the rationality of the opponent entity. Such a situation occurs, for example, in a computer game in which the player is a machine-controlled entity but the opponent is a human-controlled entity, such as in the system of FIG. 2. A technique for estimating the Lagrange multiplier βₒₚₚ corresponding to the rationality of a human-controlled opponent entity will now be described in the context of such a computer game.

Firstly, the game is played to generate a dataset D={sᵢ, aᵢ^{(pl)}, aᵢ^{(opp)}}ᵢ₌₁^{m} in which each of the m tuples corresponds to a sampled transition. During the generation of the dataset D, the machine-controlled non-playable character may be assigned an arbitrary policy. An assumption is made that the opponent selects actions according to a policy given by Equation (11). Based on this assumption, a likelihood estimator is given by:

$$P ( D \vert {β}_{opp} ) = {\prod }_{i = 1}^{m} \frac{1}{{Z}_{opp} ( {s}_{i} )} {ρ}_{opp} ( {a}_{i}^{( opp )} \vert {s}_{i} ) \times exp ( \frac{{β}_{opp}}{{β}_{pl}} {\sum }_{{a}^{( pl )}} {ρ}_{pl} ( {a}^{( pl )} \vert {s}_{i} ) exp ( {β}_{pl} {F}^{*} ( {s}_{i} , {a}^{( pl )} , {a}_{i}^{( opp )} ) ) ) , \qquad ( 17 )$$

in which

$${Z}_{opp} ( {s}_{i} ) = {\sum }_{{a}_{i}^{( opp )}} {ρ}_{opp} ( {a}_{i}^{( opp )} \vert {s}_{i} ) \times exp ( \frac{{β}_{opp}}{{β}_{pl}} {\sum }_{{a}^{( pl )}} {ρ}_{pl} ( {a}^{( pl )} \vert {s}_{i} ) exp ( {β}_{pl} {F}^{*} ( {s}_{i} , {a}^{( pl )} , {a}_{i}^{( opp )} ) ) ) . \qquad ( 18 )$$

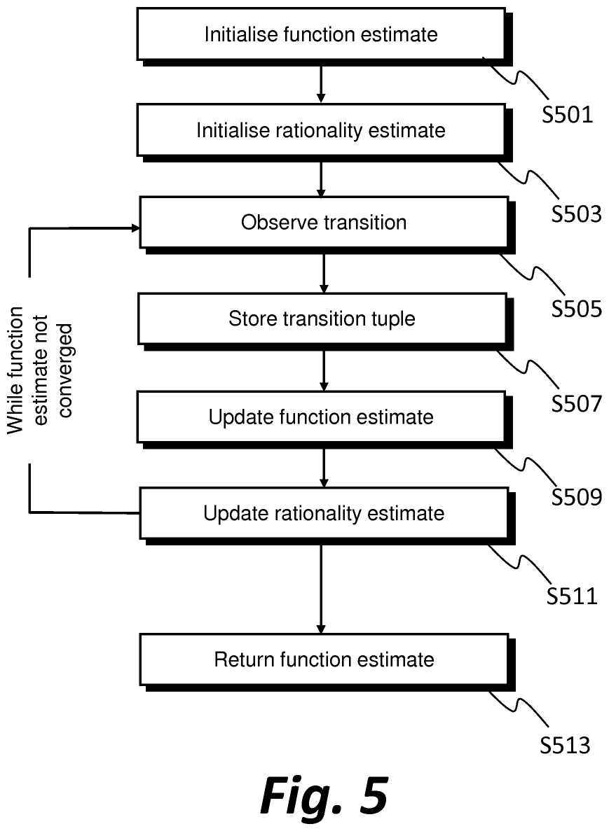

FIG. 5 represents an example of routine that is implemented by a learner to determine an estimate F(s, a^{(pl)}, a^{(opp)}) of the function F*(s, a^{(pl)}, a^{(opp)}) that solves Equations (9) to (11), as well as an estimate of βₒₚₚ, which represents the rationality of the opponent entity. The learner implements a Q-learning-type algorithm, in which the estimates are updated incrementally whilst a series of transitions in the two-entity system is observed. The learner starts by initialising, at S501, a function estimate F(s, a^{(pl)}, a^{(opp)}) to zero for all possible states and available actions for the player and the opponent. The learner also initialises, at S503, the value of βₒₚₚ to an arbitrary value. The player selects actions according to a policy as shown by Equation (5), and it is assumed that the opponent selects actions according to a fixed, but unknown, policy. The learner observes, at S505, an action of each of the two entities, along with the corresponding transition from a state sₜ to successor state sₜ′. The learner stores, at S507, a tuple of the form (sₜ, aₜ^{(pl)}, aₜ^{(opp)}, s′ₜ) associated with the transition.

The learner updates, at S509, the function estimate F(s, a^{(pl)}, a^{(opp)}). In this example, in order to update the function estimate F(s, a^{(pl)}, a^{(opp)}), the learner first substitutes the present estimate of F(s, a^{(pl)}, a^{(opp)}) into Equation (10) to calculate an estimate F(sₜ, aₜ^{(pl)}) of F*(sₜ, aₜ^{(pl)}), then substitutes the calculated estimate F(sₜ, aₜ^{(pl)}) into Equation (11) to calculates an estimate F(s′ₜ) of F*(s′ₜ). The learner then uses the estimate F(s′ₜ) to update the estimate F(s, a^{(pl)}, a^{(opp)}), using the rule shown by Equation (19):

F(sₜ,aₜ^{(pl)},aₜ^{(opp)})←F(sₜ,aₜ^{(pl)},aₜ^{(opp)})+a(Rₜ+γF(s′ₜ)−F(sₜ,aₜ^{(pl)},aₜ^{(opp)})). (19)

The learner updates, at S511, the estimate of βₒₚₚ using the rule shown by Equation (20):

$${β}_{opp} ← {β}_{opp} + {α}_{2} \frac{\partial }{\partial {β}_{opp}} log P ( D \vert {β}_{opp} ) . \qquad ( 20 )$$

The learner continues to update the estimates F*(s, a^{(pl)}, a^{(opp)}) and βₒₚₚ as transitions are observed until predetermined convergence criteria are satisfied. The learner returns, at S513, the converged function estimate F(s, a^{(pl)}, a^{(opp)}), which is an approximation of the optimal function F*(s, a^{(pl)}, a^{(opp)}). Note that at each iteration within the algorithm, log P(D|βₒₚₚ) and its partial derivative with respect to βₒₚₚ are computed, which depend on m previous transitions.

When the Q-learning algorithm has converged to satisfactory estimates of F*(s, a^{(pl)}, a^{(opp)}) and βₒₚₚ, the player policy that optimises the objective of Equation (8) is given by Equation (13).

### Summary of Routines

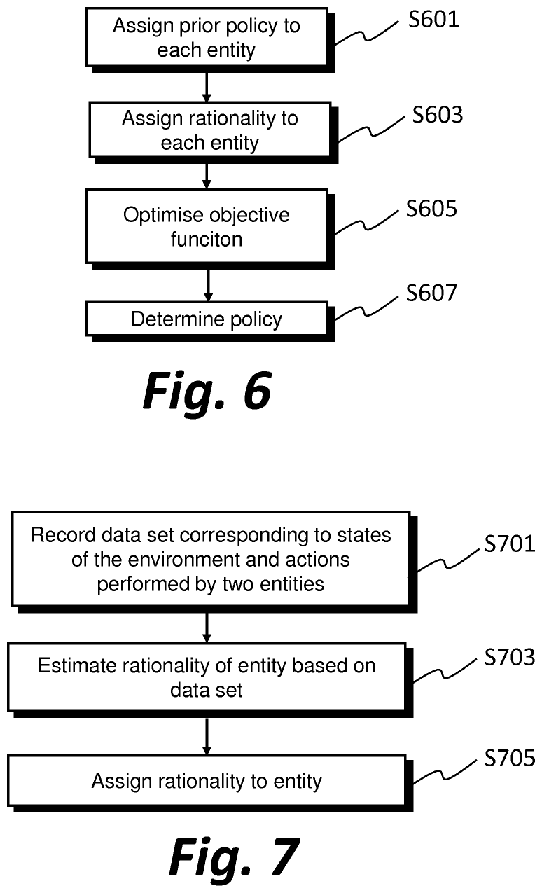

As shown in FIG. 6, a routine in accordance with the present invention involves assigning, at S601, a prior policy to each of the two entities in the decision making system. The prior policies of the player and the opponent are denoted ρₚₗ and ρₒₚₚ respectively.

The routine assigns, at S603, a rationality to each entity. The rationalities of the player and the opponent are given by βₚₗ and βₒₚₚ respectively. In the case of two agents, βₚₗ and βₒₚₚ are parameters to be selected. In the case in which the player is an agent but the opponent is an entity with an unknown rationality, βₚₗ is is a parameter, and one of the objectives of the routine is to estimate βₒₚₚ.

The routine optimises, at S605, an objective function. In some examples, optimising the objective function is achieved using an off-policy learning algorithm such as a Q-learning-type algorithm, in which a function F(s, a^{(pl)}, a^{(opp)}) is updated iteratively.

The routine determines, at S607, a policy for the player. In some examples, the determined policy is determined from the objective function by Equation (13). In the example that both the player and the opponent are agents, the routine also determines a policy for the opponent using Equation (14).

As shown in FIG. 7, in a case in which the opponent is an entity with an unknown rationality, the routine records, at S701, a data set corresponding to states of the environment and actions performed by the player and the opponent.

The routine estimates, at S703, the rationality βₒₚₚ of the opponent based on the data set. In some examples, this is done using an extension to a Q-learning-type algorithm, in which an estimate of βₒₚₚ is updated along with the function F(s, a^{(pl)}, a^{(opp)}). In one example, this update is achieved using Equation (20).

The routine assigns, at S705, the estimated rationality βₒₚₚ to the opponent.

### Deep Neural Networks

For problems with high dimensional state spaces, it is necessary to use function approximators to estimate the function F*(s, a^{(pl)}, a^{(opp)}). In some examples, deep Q-networks, which are Deep Neural Networks (DNNs) applied in the context of Q-learning-type algorithms, are used as function approximators. Compared with other types of function approximator, DNNs have advantages with regard to the complexity of functions that can be approximated and also with regard to stability.

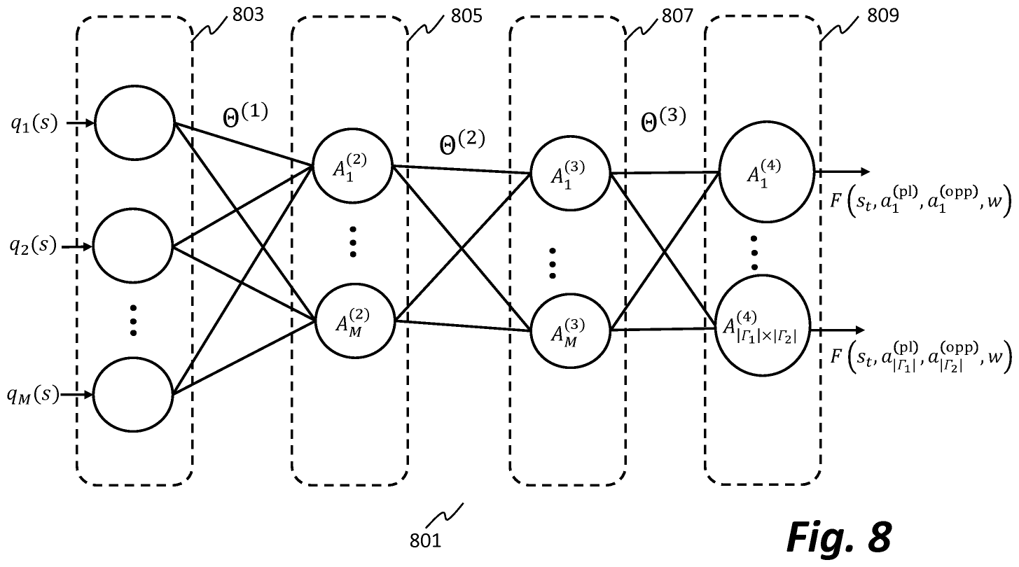

FIG. 8 shows a first DNN 801 used to approximate the function F*(s, a^{(pl)}, a^{(opp)}) in one example of the invention. First DNN 801 consists of input layer 803, two hidden layers: first hidden layer 805 and second hidden layer 807, and output layer 809. Input layer 803, first hidden layer 805 and second hidden layer 807 each has M neurons and output layer 809 has |Γ₁|×|Γ₂| neurons, where Γ₁ is the set of actions available to the player and Γ₂ is the set of actions available to the opponent. Each neuron of input layer 803, first hidden layer 605 and second hidden layer 807 is connected with each neuron in the subsequent layer. The specific arrangement of hidden layers, neurons, and connections is referred to as the architecture of the network. A DNN is any artificial neural network with multiple hidden layers, though the methods described herein may also be implemented using artificial neural networks with one or zero hidden layers. Different architectures may lead to different performance levels depending on the complexity and nature of the function F*(s, a^{(pl)}, a^{(opp)}) to be learnt. Associated with each set of connections between successive layers is a matrix Θ^{(j)} for j=1, 2, 3 and for each of these matrices the elements are the connection weights between the neurons in the preceding layer and subsequent layer.

First DNN 801 takes as its input a feature vector q representing a state s, having components qᵢ for i=1, . . . , M. The output of DNN 801 is a |Γ₁|×|Γ₂| matrix denoted F(s, a^{(pl)}, a^{(opp)}; w), and has components F(s, aᵢ^{(pl)}, aⱼ^{(opp)};w) for i=1, . . . , |Γ₁|, j=1, . . . , |Γ₂|. The vector of weights w contains the elements of the matrices Θ^{(j)} for j=1, 2, 3, unrolled into a single vector.

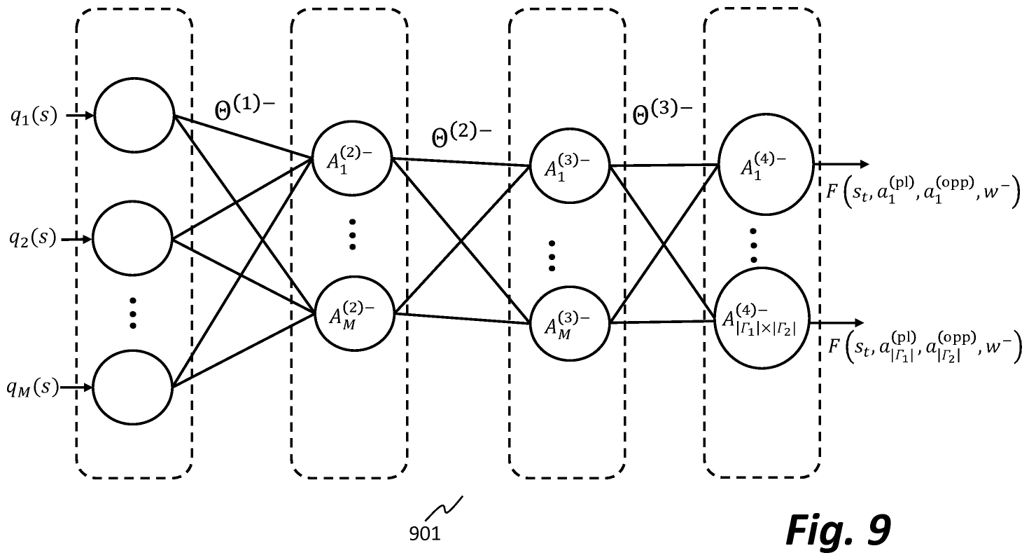

As shown in FIG. 9, second DNN 901 has the same architecture as first DNN 801. Initially, the vector of weights w⁻ of second DNN 901 is the same as the vector of weights w of DNN 801. However, the vector of weights w⁻ is not updated every time the vector of weights w is updated, as described hereafter. The output of second DNN 901 is denoted F(s, a^{(pl)}, a^{(opp)}; w⁻)

In order for first DNN 801 and second DNN 901 to be used in the context of the routine of FIG. 6 (or FIG. 7), the learner initialises the elements of the matrices Θ^{(j)} for j=1, 2, 3, at S601 (or S701), to values in an interval [−δ, δ], where δ is a small user-definable parameter. The elements of the corresponding matrices in second DNN 901 are initially set to the same values as those of first DNN 801, such that w⁻←w.

The learner observes, at S603 (or S705), an action of each of the two entities, along with the corresponding transition from a state sₜ to successor state sₜ′. The learner stores, at S605 (or S707), a tuple of the form (sₜ, aₜ^{(pl)}, aₜ^{(opp)}, s′ₜ) associated with the transition, in a replay memory, which will later be used for sampling transitions.

The learner implements forward propagation to calculate a function estimate F(s, a^{(pl)}, a^{(opp)}; w). The components of q are multiplied by the components of the matrix Θ⁽¹⁾ corresponding to the connections between input layer 803 and first hidden layer 805. Each neuron of first hidden layer 805 computes a real number Aₖ⁽²⁾=g(z), referred to as the activation of the neuron, in which z=ΣₘΘₖₘ⁽¹⁾qₘ is the weighted input of the neuron. The function g is generally nonlinear with respect to its argument and is referred to as the activation function. In this example, g is the sigmoid function. The same process of is repeated for second hidden layer 807 and for output layer 809, where the activations of the neurons in each layer are used as inputs to the activation function to compute the activations of neurons in the subsequent layer. The activation of the neurons in output later 809 are the components of the function estimate F(s, a^{(pl)}, a^{(opp)}; w).

The learner updates the function estimate, at S607 (or S709), by minimising a loss function L(w) given by

L(w)= [symbol] [(R(s,a^{(pl)},a^{(opp)})+γF(s;w⁻)−F(s,a^{(pl)},a^{(opp)};w))²], (21)

where F(s; w⁻) is calculate from F(s, a^{(pl)}, a^{(opp)}; w⁻) using Equations (10) and (11). The expectation value in Equation (21) is estimated by sampling over a number Nₛ of sample transitions from the replay memory, calculating the quantity in square brackets for each sample transition, and taking the mean over the sampled transitions. In this example, Nₛ=32.

In order to minimise (21), the well-known backpropagation algorithm is used to calculate gradients of the function estimate F(s, a^{(pl)}, a^{(opp)}; w) with respect to the vector of parameters w, and gradient descent is used to vary the elements of w such that the loss function L(w) decreases. After a number N_{T} of transitions have been observed, and correspondingly N_{T} learning steps have been performed, the elements of the weight matrices in second DNN 901 are updated to those of first DNN 801, such that w⁻←w. In this example, N_{T}=10000. Sampling transitions from a replay memory and periodically updating a second DNN 901 (sometimes referred to as a target network) as described above allows the learning routine to handle non-stationarity.

### Example Computer Devices for Implementing Learning Methods

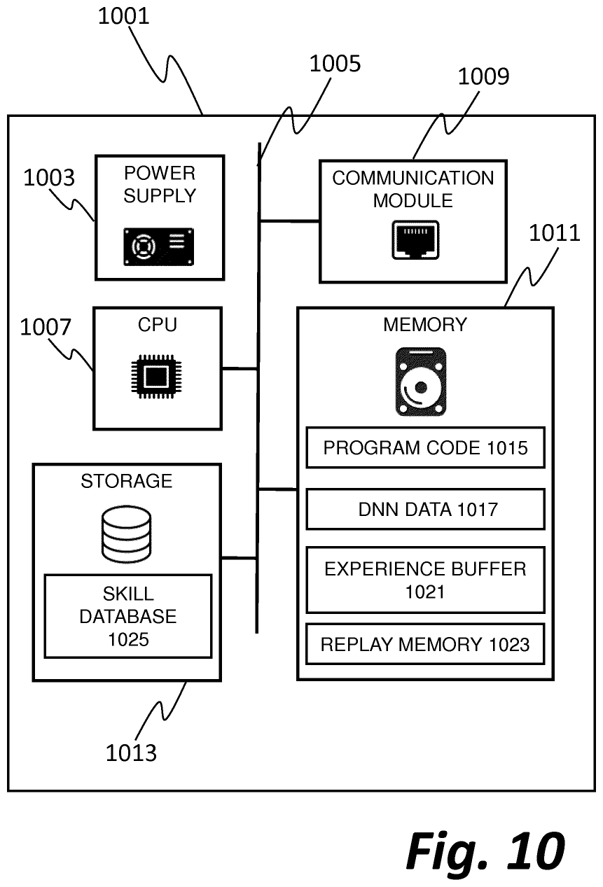

FIG. 10 shows server 1001 configured to implement a learning subsystem in accordance with the present invention in order to implement the methods described above. In this example, the learning subsystem is implemented using a single server, though in other examples the learning subsystem is distributed over several servers. Server 1001 includes power supply 1003 and system bus 1005. System bus 1005 is connected to: CPU 1007; communication module 1009; memory 1011; and storage 1013. Memory 1011 stores program code 1015; DNN data 1017; experience buffer 1021; and replay memory 1023. Storage 1013 stores skill database 1025. Communication module 1009 receives experience data from an interaction subsystem and sends policy data to the interaction subsystem (thus implementing a policy sink).

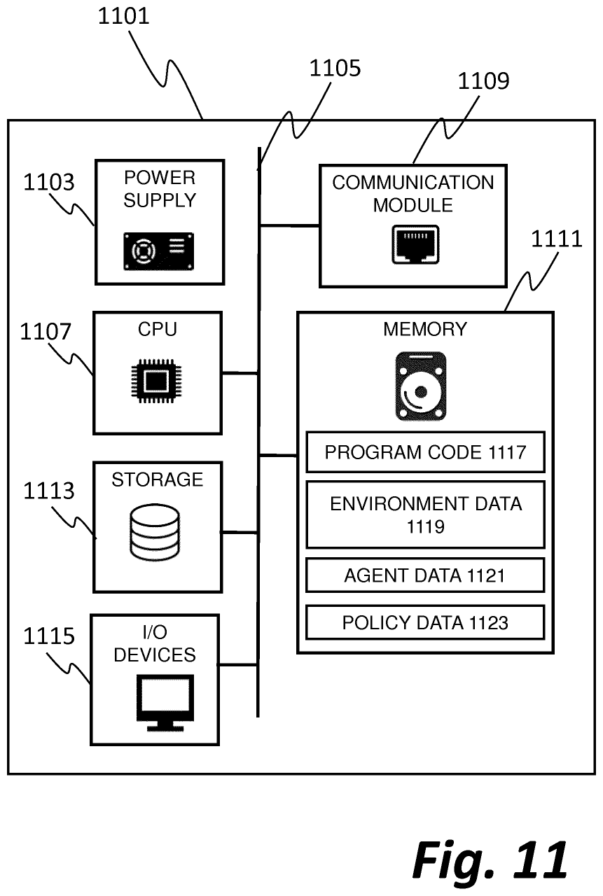

FIG. 11 shows local computing device 1101 configured to implement an interaction subsystem in accordance with the present invention in order to implement the methods described above. Local computing device 1101 includes power supply 1103 and system bus 1105. System bus 1105 is connected to: CPU 1107; communication module 1109; memory 1111; storage 1113; and input/output (I/O) devices 1115. Memory 1111 stores program code 11117; environment data 1119; agent data 1121; and policy data 1123. In this example, I/O devices 1115 include a monitor, a keyboard, and a mouse. Communication module 1109 receives policy data from server 1001 (thus implementing a policy source) and sends experience data to server 1001 (thus implementing an experience sink).

The above embodiments are to be understood as illustrative examples of the invention. Further embodiments of the invention are envisaged. In particular, the system architectures illustrated in FIGS. 1 and 2 are exemplary, and the methods discussed in the present application could alternatively be performed, for example, by a stand-alone server, a user device, or a distributed computing system not corresponding to either of FIG. 1 or 2.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1-15. (canceled)

16. A machine learning system comprising:
memory circuitry;
processing circuitry; and
an interface for communicating with a first entity and a second entity interacting with one another in an environment, wherein the first entity is controlled by an automated agent and the second entity acts in accordance control signals derived from human inputs,
wherein the memory circuitry stores machine-readable instructions which, when executed by the processing circuitry, cause the machine learning system to:
assign a respective prior policy to each of the first entity and the second entity;
assign a rationality to the first entity for controlling a permitted divergence of a current policy of the first entity from the prior policy assigned to the first entity;
record a data set comprising a plurality of tuples, each tuple comprising data indicating a state of the environment at a given time and respective actions performed by the first entity and the second entity in said state of the environment;
process the data set to determine, by optimising an objective function F*(s), an estimated rationality for the second entity and an updated current policy for the first entity, wherein the objective function F*(s) is dependent on the respective rationalities and prior policies of the first entity and the second entity; and
update the rationality to the first entity in dependence on the estimated rationality of the second entity.

17. The machine learning system of claim 16, wherein the objective function F*(s) corresponds to an expected value of future rewards following actions performed by the first entity and the second entity in a state s constrained by the respective rationalities of the first entity and the second entity.

18. The machine learning system of claim 17, wherein for each of the first entity and the second entity, the objective function F*(s) includes a respective Kullback-Leibler, KL, divergence of a current policy of that entity from the prior policy assigned to that entity.

19. The machine learning system of claim 18, wherein the rationality for each entity corresponds to a Lagrange multiplier for the respective KL divergence.

20. The machine learning system of claim 19, wherein the objective function F*(s) is mathematically equivalent to:
$${F}^{*} ( s ) = {max}_{{π}_{1}} {ext}_{{π}_{2}} 𝔼 [ {\sum }_{t = 0}^{∞} {γ}^{t} ( R ( {s}_{t} , {a}_{t}^{( 1 )} , {a}_{t}^{( 2 )} ) - \frac{1}{{β}_{1}} log \frac{{π}_{1} ( {a}_{t}^{( 1 )} \vert {s}_{t} )}{{ρ}_{1} ( {a}_{t}^{( 1 )} \vert {s}_{t} )} - \frac{1}{{β}_{2}} log \frac{{π}_{2} ( {a}_{t}^{( 2 )} \vert {s}_{t} )}{{ρ}_{2} ( {a}_{t}^{( 2 )} \vert {s}_{t} )} ) ]$$
where:
R(sₜ, aₜ⁽¹⁾, aₜ⁽¹⁾) is a joint reward when in a state sₜ of the environment the first entity performs an action aₜ⁽¹⁾ and the second entity performs an action aₜ⁽²⁾;
β₁ is the Lagrange multiplier corresponding to the rationality of the first entity;
β₂ is the Lagrange multiplier corresponding to the rationality of the second entity;
π₁ is the current policy of the first entity;
ρ₁ is the prior policy of the first entity;
π₂ is the current policy of the second entity; and
ρ₂ is the prior policy of the second entity.

21. The machine learning system of claim 16, wherein the first entity and the second entity are entities within a computer game.

22. A machine learning method of determining a policy for an agent controlling a first entity in a system comprising a first entity and a second entity, wherein the first entity is controlled by an automated agent, the method comprising:
assigning a respective prior policy and a respective rationality to each of the first entity and the second entity, wherein the respective rationality assigned to each entity controls a permitted divergence of a current policy associated with that entity from the prior policy assigned to that entity; and
determining the current policy associated with the first entity by optimising an objective function F*(s),
wherein the objective function F*(s) is dependent on the respective rationalities and prior policies assigned to the two entities.

23. The machine learning method of claim 22, wherein the objective function F*(s) corresponds to an expected value of future rewards following actions performed by the first entity and the second entity in a state s constrained by the respective rationality assigned to each entity.

24. The machine learning method of claim 23, wherein for each of the first entity and the second entity, the objective function F*(s) includes a respective Kullback-Leibler, KL, divergence of the current policy associated with that entity from the prior policy assigned to that entity.

25. The machine learning method of claim 24, wherein the assigned rationality for each entity corresponds to a Lagrange multiplier for the respective KL divergence.

26. The machine learning method of claim 25, wherein the objective function F*(s) is mathematically equivalent to:
$${F}^{*} ( s ) = {max}_{{π}_{1}} {ext}_{{π}_{2}} 𝔼 [ {\sum }_{t = 0}^{∞} {γ}^{t} ( R ( {s}_{t} , {a}_{t}^{( 1 )} , {a}_{t}^{( 2 )} ) - \frac{1}{{β}_{1}} log \frac{{π}_{1} ( {a}_{t}^{( 1 )} \vert {s}_{t} )}{{ρ}_{1} ( {a}_{t}^{( 1 )} \vert {s}_{t} )} - \frac{1}{{β}_{2}} log \frac{{π}_{2} ( {a}_{t}^{( 2 )} \vert {s}_{t} )}{{ρ}_{2} ( {a}_{t}^{( 2 )} \vert {s}_{t} )} ) ]$$
where:
R(sₜ, aₜ⁽¹⁾, aₜ⁽¹⁾) is a joint reward when in a state sₜ the first entity performs an action aₜ⁽¹⁾ and the second entity performs an action aₜ⁽²⁾;
β₁ is the Lagrange multiplier corresponding to the rationality of the first entity;
β₂ is the Lagrange multiplier corresponding to the rationality of the second entity;
π₁ is the current policy of the first entity;
ρ₁ is the prior policy of the first entity;
π₂ is the current policy of the second entity; and
ρ₂ is the prior policy of the second entity.

27. The machine learning method of claim 26, wherein if the first entity and the second entity collaborate with one another
$${ext}_{{π}_{2}} is max ,$$
and if the first entity and the second entity oppose one another
$${ext}_{{π}_{2}} is min .$$

28. The machine learning method of claim 22, wherein the second entity acts in accordance with control signals derived from human inputs.

29. The machine learning method of claim 28, wherein assigning the respective rationality to the second entity comprises:
recording a data set comprising a plurality of tuples, each tuple comprising data indicating a state at a given time and respective actions performed by the first entity and the second entity in that state;
processing the data set to determine an estimated rationality of the second entity; and
assigning the rationality of the second entity in dependence on the estimated rationality of the second entity.

30. The machine learning method of claim 29, wherein the estimated rationality of the second entity is determined using a likelihood estimator given by:
$$P ( D \vert {β}_{2} ) = {\prod }_{i = 1}^{m} \frac{1}{{Z}_{2} ( {s}_{i} )} {ρ}_{2} ( {a}_{i}^{( 2 )} \vert {s}_{i} ) \times exp ( \frac{{β}_{2}}{{β}_{1}} {\sum }_{{a}^{( 1 )}} {ρ}_{pl} ( {a}^{( 1 )} \vert {s}_{i} ) exp ( {β}_{1} {F}^{*} ( {s}_{i} , {a}^{( 1 )} , {a}_{i}^{( 2 )} ) ) )$$
in which:
$${Z}_{2} ( {s}_{i} ) = {\sum }_{{a}_{i}^{( 2 )}} {ρ}_{2} ( {a}_{i}^{( 2 )} \vert {s}_{i} ) \times exp ( \frac{{β}_{2}}{{β}_{2}} {\sum }_{{a}^{( 2 )}} {ρ}_{1} ( {a}^{( 1 )} \vert {s}_{i} ) exp ( {β}_{1} {F}^{*} ( {s}_{i} , {a}^{( 1 )} , {a}_{i}^{( 2 )} ) ) ) .$$

31. The machine learning method of claim 29, further comprising updating the respective rationality of the first entity in dependence on the estimated rationality of the second entity.

32. The machine learning method of claim 22, wherein:
the agent controlling the first entity is a first agent; and
the second entity acts in accordance with control signals from a second agent,
the method further comprising determining a current policy for the second agent.

33. The machine learning method of claim 22, further comprising the agent:
receiving a state signal from an environment indicating that the environment is in a state s; and
selecting an action aₜ⁽¹⁾ for the first agent from a set of available actions in accordance with the determined policy; and
transmitting an action signal indicating the selected action aₜ⁽¹⁾.

34. The machine learning method of claim 22, wherein the system comprises a computer game.

35. A non-transient storage medium comprising machine-readable instructions which, when executed by a computing system, cause the computing system to:
assign a respective prior policy and a respective rationality to each of a first entity and a second entity in a system, the rationality assigned to each entity controlling a permitted divergence of a current policy associated with that entity from the prior policy assigned to that entity; and
determine a policy for an automated agent controlling the first entity in the system by optimising an objective function F*(s),
wherein the objective function F*(s) includes factors dependent on the respective rationalities and prior policies assigned to the first entity and the second entity.
